(19) United States
(12) Patent Application Publication
(10) Pub. No.: US 2020/0118057 A1
(43) Pub. Date: Apr. 16, 2020

(54) Cloud-Based Storage/Software System for Service Contractors

(71) Applicant: Michael Fallis, Trevose, PA (US)

(72) Inventor: Michael Fallis, Trevose, PA (US)

(21) Appl. No.: 16/653,563

(22) Filed: Oct. 15, 2019

Related U.S. Application Data
(60) Provisional application No. 62/745,637, filed on Oct. 15, 2018.

(51) Int. Cl. G06Q 10/06; G06Q 10/10; G06Q 40/00; G06F 16/182

(52) U.S. Cl. CPC G06Q 10/063112; G06Q 10/1053; G06F 16/182; G06Q 40/125; G06Q 10/1091

(57) ABSTRACT

A cloud-based storage/software system for service contractors is disclosed. The software enables a user to create contracts, estimates/proposals, addendums, and change orders. A customizable customer and project database assist contractors with entering basic data into the system. The software also includes a form for entering payment structure information for the proposed work/service and a running dialogue box that assists in creating the payment structure. An addendum section allows for modifications to the original proposal and saves the new proposal for comparison to the original. If a proposal is accepted, an additional set of features, including add payment, add expense, add change order, and add selections are activated. The software further allows for the creation of simple invoices for recording basic tasks that are completed, and a fully customizable settings menu.

### CROSS REFERENCE TO RELATED APPLICATION

This application claims the benefit of U.S. Provisional Application No. 62/745,637, filed on Oct. 15, 2018, entitled “Cloud-Based Storage/Software System for Service Contractors.” The above identified patent application is herein incorporated by reference in its entirety to provide continuity of disclosure.

### BACKGROUND OF THE INVENTION

### 1. Field of the Invention

The present invention relates to cloud-based storage/software systems for service contractors. More particularly, the present invention pertains to a cloud-based system that enables contractors to quickly and efficiently create contracts, estimates/proposals, addendums, and change orders through a storage/software system.

A contractor is an independent entity that agrees to furnish a certain number/quantity of goods and/or services that meet or exceed stated requirements/specifications at a mutually agreed upon price and within a specified timeframe. Contractors are often hired for a variety of jobs, such as to remodel a home, to remove snow from a parking lot, to manufacture parts, or to clean an apartment. As is well known, contractors make up a large portion of small businesses and employ millions of workers.

Due to the varying nature of the work that a contractor is hired to complete, no two jobs are exactly the same. An example of the differences a contractor may encounter include the size of a lawn to be mowed, the amount of lumber required to frame a structure, or the gallons of paint required to paint a building. As can be appreciated, these variables must be accounted for when determining the amount to charge for the specified goods and/or services. The general manner for handling this information and conveying it to a prospective client is through a proposal or estimate.

Creating accurate proposals/estimates in a cost-effective and efficient manner is one of the keys to being a successful contractor. If errors exist in an accepted proposal that becomes a contract, the contractor may be required to pay for the discrepancy, which can reduce profits or even cause the contractor to experience an overall loss on the project. Additionally, creating accurate proposals enables a contractor to place competitive bids on a job in order to win a contract. By knowing the exact amount it will cost to complete a project, a contractor can more competitively bid on a contract by adding using a margin for error while still ensuring that the job will be profitable and advantageous.

As can be appreciated from the foregoing, contract estimation constitutes a substantial portion of the cost incurred by many contractors. Some of these costs include the administration of bids, personnel management, generating documents for financing, and allowances for alterations or errors in the estimation process. Additionally, estimation errors may cause to the contractor to incur fees for dispute resolution related to contract obligations or performance responsibility, and the costs related to change orders.

To create proposals/estimates, contractors often perform the calculations by hand or utilize non-specialized software, such as Microsoft Excel, where they create a template with formulas that calculate the required information. These methods, however, require the contractor to enter their own formulas, which is a method that is prone to error. Other methods for creating proposals/estimates include specialized software that enables a user to enter basic data into a computer, wherein the software performs standardized calculations and outputs the data into a template. These programs, however, offer very little flexibility, and cannot be customized by the user.

As can be seen by the foregoing, a need exists for assisting contractors with creating estimates/proposals, addendums, and change orders in a customizable and efficient manner.

### 2. Description of the Prior Art

Devices have been disclosed in the prior art that relate to software systems for service contractor. These include devices that have been patented and published in patent application publications. These devices generally relate to cloud-based storage/software programs for service contractors to facilitate the drafting of contracts and proposals. The following is a list of devices deemed most relevant to the present disclosure, which are herein described for the purposes of highlighting and differentiating the unique aspects of the present invention, and further highlighting the drawbacks existing in the prior art.

U.S. Patent Application Publication No. US 2006/0085322 A1 discloses a method of subdividing and defining the scope of work and for inter-linking construction plans/specifications to construction contracts to eliminate errors and uncertainty in contractor performance. Electronic overlays are applied onto the digitized construction plans corresponding to different categories of work. Each overlay is divided into a series of optimized subdivision boxes which uniquely identify/locate on the plans work to be performed. Overlays and boxes are linked to the subcontracts so the scope of work to be bid is accurately mapped to corresponding regions and overlay category on the architectural drawings. This method, however, does not disclose a form for entering payment structure for proposed work/service and running dialogue box for payment structure.

U.S. Pat. No. 8,935,179 B2 discloses a system for providing automated quotes and proposals, including a server computer, a network communication interface configured for communication with other computers; a web server configured to interface with a client software application running on the client computer; and a proposal engine. The system may be configured to receive selections of items corresponding to a proposal from a user via a user interface; to generate, select, or receive at least a portion of a Deep Web network address corresponding to the proposal; and to cause the display of the proposal, including the selected items for viewing at the Deep Web network address. This system, however, does not provide a form for entering payment structure for proposed work/service and a running dialogue box for payment structure, or an addendum section that allows for modification of original proposal for comparison to the original.

U.S. Patent Application Publication No. 2014/0222608 A1 discloses a home remodeling cost estimator tool for creating a cost breakdown for remodeling a house or a room. The system utilizes photos from websites and other proprietary data sources. For any photo in a photo database for such design sites, a user can work with the estimator to generate a price estimate and a breakdown for a building project. This system, however, does not provide a form for entering payment structure for proposed work/service and a running dialogue box for payment structure, or an addendum section that allows for modification of original proposal for comparison to the original.

U.S. Pat. No. 7,330,821 B2 discloses an e-commerce based construction industry bidding and project management system for document distribution, supply chain automation, and on-line auctioning. In a pre-construction setting, the e-commerce based bidding and project management system provides a user with the means for participating and competing in the bidding and construction project management tasks. The on-line system helps the participants to achieve cost efficiencies and performance enhancements when compared to traditional manual bidding and construction management systems. This system, however, does not provide a form for entering payment structure for proposed work/service and a running dialogue box for payment structure, or an addendum section that allows for modification of original proposal for comparison to the original.

U.S. Patent Application Publication No. 2008/0154631 A1 discloses a system for the management of service elements and/or service offerings that is facilitated by a Service Development Tool. The management includes various tasks associated with creating, modifying and deleting service elements, establishing relationships, error checking and optimization. In a further aspect, service elements are packaged and distributed to enable customers to deliver the service elements. Additionally, the hosting of software packages is facilitated. This system, however, does not provide a form for entering payment structure for proposed work/service and a running dialogue box for payment structure, or an addendum section that allows for modification of original proposal for comparison to the original.

### SUMMARY OF THE INVENTION

The present invention overcomes the problems inherent with current methods for creating estimates/proposals by providing a new and improved system that can be fully customized based on the needs of a contractor. The system includes a cloud-based storage/software program that is tailored for use by contractors. The software enables a user to draft contracts and create estimates/proposals, addendums, change orders, and simple invoices in a quick and efficient manner. The software utilizes a fully customizable customer database and a project database that populate the key data for the proposals/estimates. The software also provides a form for entering payment structure information for the proposed work/service and a running dialogue that assists in creating the payment structure. An addendum section allows for modification to the original proposal and saves the new proposal for comparison to the original. If a proposal is accepted, an additional set of features, including add payment, add expense, add change order, and add selections are activated. For basic jobs that do not require a proposal, a simple invoice section provides a means for creating a record and bill for a completed task. Also included in the system is a fully customizable settings page that allows a user to change the settings for many aspects of the software.

The present invention substantially diverges in its method from the prior art and consequently it is clear that there is a need in the art for an improved software system for writing contracts, estimates/proposals, addendums, and change orders. In this regard the instant invention substantially fulfills these needs.

### OBJECTS OF THE INVENTION

In view of the foregoing disadvantages inherent in the known types of contract creation software now present in the prior art, the present invention provides a new cloud-based storage/software program wherein the same can be utilized for drafting contracts and creating estimates/proposals, addendums, change orders, and simple invoices in a quick and efficient manner.

It is therefore an object of the present invention to provide a new and improved cloud-based storage/software program that has all of the advantages of the prior art and none of the disadvantages.

It is another object of the present invention to provide a cloud-based storage/software program that enables a user to create contracts, estimates/proposals, addendums, and change orders.

Another object of the present invention is to provide a cloud-based storage/software program with a customizable customer and project database that assists contractors with entering basic data into the system.

Yet another object of the present invention is to provide cloud-based storage/software program that utilizes a form for entering payment structure information for the proposed work/service and a running dialogue box that assists in creating the payment structure.

Another object of the present invention is to provide a cloud-based storage/software program with an addendum section that allows for modifications to the original proposal and saves the new proposal for comparison to the original.

A final object of the present invention is to provide a cloud-based storage/software program that allows for the creation of simple invoices for recording basic tasks that are completed, and a fully customizable settings menu

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings.

FIG. 1 shows a flowchart illustrating the steps for estimate creation.

FIG. 2 shows a flowchart illustrating the steps for addendum creation.

FIG. 3 shows a flowchart illustrating the steps for contract awarding.

### DETAILED DESCRIPTION OF THE INVENTION

Reference is made herein to the attached drawings. For the purposes of presenting a brief and clear description of the present invention, the preferred embodiment will be discussed as used for creating contracts, estimates/proposals, addendums, and change orders. The figures are intended for representative purposes only and should not be considered to be limiting in any respect.

The present invention discloses a cloud-based storage/software system that enables users to draft contracts, estimates/proposals, and addendums. The software further allows for the creation of change orders once a project is underway, and for the creation of invoices for the simple recordation of completed tasks. The software is fully customizable based on the needs of the individual user.

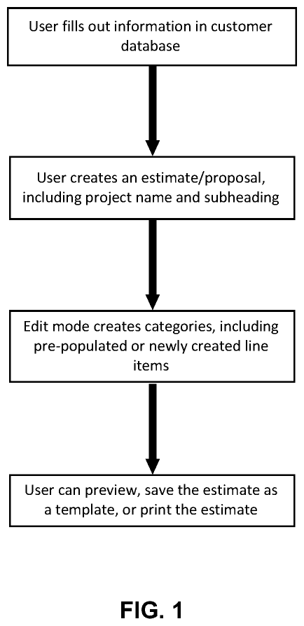

Referring now to FIG. 1, there is shown a flowchart illustrating the steps for estimate creation. The methods and system of the present invention are best practiced through a website. Preferably, the system functions as cloud-based software for contractors, home remodelers, service contractors, and the like. The system can be customized for anyone that needs to provide clients with an estimate or contract.

The system utilizes a cloud-based customer database. The database stores contact information, including name, address, phone, email, project type, allowance levels that can be tiered (i.e. levels 1-3), and the like. Client data can be modified/edited as needed. Also included in the customer database is a client status menu that contains information such as, new lead, current customer (project in progress), archived (cold leads), and the like.

An example of the items available in the Admin Portal is found in Table I:

TABLE I
ADMIN PORTAL (HOME)

```
NAVIGATION BUTTONS FOR
    Client list
    Add new client
    Add project expense
    Add payment
UPCOMING PAYMENTS DUE PANE
    Table view shows list of clients with upcoming payments due
    Each table row includes
        Client name (clickable hyperlink to client page)
        Account icon (hyperlink to view client account (expenses
        and payments, payment
        schedule, etc.))
        Estimate number
        Payment term/amount
        Current remaining amount for project
        Mark paid button to mark payment status as paid
    Footer table row shows total of all “payments due” across clients and
    total “current remaining”
    for all clients, below their respective column
    My Todo List pane
        Table showing items in todo list includes
        Date entered
        Label (category; client name (if related to specific client) or
        company (if related to a general company task)))
        Task
        Button to mark/unmark completed
    Button to archive todo items marked completed
    Form to enter new tasks for todo list
        Text field for new tasks
        Dropdown for label (category)
        Dropdown includes client names and a selection “company” for
        general tasks
```

An example of the data fields relating to company details is found in Table II:

TABLE II
COMPANY DETAILS

| MENU FUNCTION | Setting to be Changed |
|---|---|
| CHANGE PASSWORD | User login password |
| EDIT COMPANY NAME | As it appears on software generated copy |
| STATE LICENSE NUMBER | As it appears on software generated copy |
| COMPANY ADDRESS | As it appears on software generated copy |
| COMPANY PHONE | As it appears on software generated copy |
| NUMBER | |
| COMPANY FAX NUMBER | As it appears on software generated copy |

An example of the menu functions related to terms and conditions that can be edited are found in Table III:

TABLE III
EDIT TERMS AND CONDITIONS

| MENU FUNCTION | Setting to be Changed |
|---|---|
| TURN ON/OFF “RIGHT | As it appears on software generated copy |
| TO RESCIND” EDIT | As it appears on the footer of a proposal |
| TERMS AND CONDITIONS | Date (Today's date) |
| ADD PLACEHOLDERS | Companyname (Your company name) |
| WITHIN THE TERMS | Owner (Client's full name) |
| AND CONDITIONS | Owneraddress (Client's full address) |
| | Totaljob (Full project cost) |
| | Downpayment (First scheduled payment |
| | from payment terms) |
| | Company state (State in which your |
| | company resides) |

* A preview pane is provided at bottom to view results of changes

Once the required information is populated in the customer database, a user can create an estimate/proposal. This is accomplished with a menu that enables a user to create a new project. Once this is selected, the contractor is provided with an opportunity to name the new project (i.e. Jones Remodel). The user can then create a heading name that relates to the work to be completed in the project (i.e. first floor bathroom, windows, etc.).

When the project name and subheading are created, the contractor can then enter edit mode, which is a user interface (UI) that assists with the creation of the estimate. Edit mode begins with the selection (or creation of) a category. As a non-limiting example, in each category (i.e. removal), a user can choose an action (fully customizable by category) from saved items (i.e. remove, install, or replace, etc.) and can also add a quantity and a measurement (fully customizable by category) (i.e. square feet, cubic feet, etc.).

To expedite the process, a user is provided with the ability to create pre-populated line items ahead of time, wherein each item is customizable by category in a settings menu. The settings menu saves the information and allows it to be displayed for repeated or future use as needed. A non-limiting example would be a proposal to remove nine existing windows. As can be appreciated, “Existing Windows” may be a category that a window installer includes in most proposals, therefore, including it as a pre-populated line item for later use is more efficient than filling out the same information for every new proposal. Once a line item is entered into the proposal it is saved. The software does not include a save button, but instead continually saves work as it is completed, which prevents items from being inadvertently lost. All line items can be completely edited, deleted, or duplicated once they are added. Additionally, line items can be re-ordered within a category by drag and drop for increased efficiency during the creation process.

If a pre-populated line item does not exist, it can be added as a custom line item with the option to save it and categorize it for later use. If saved, the system stores the custom item, quantity, price, and description, inserts a price for the line item, and provides a fillable description box for the line item (which can be populated with the use of semicolons that function as separators and force each separation into a new bullet point in the final print). Additionally, the user can choose markup or not, adjust markup rate, whether the item is taxable or not, can adjust the tax rate, and is provided with a button to add the line item to the proposal. Each category is fully customizable. A button to “edit category” is found in the top right corner of every category. “Edit Category” features include editing font and background color of category as displayed in the user interface, edit the default line items (which are best used for items that are commonly associated with quantities) within that category, edit the default actions for that category (install, remove, etc.), and finally, edit the custom line items for that category. Each category is templatable. A user can save the line items in a category as a template. There is a button in the top right corner of each category to save as template or select a template to import.

An example of the menu functions related to workflow categories that can be edited are found in Table IV:

TABLE IV
EDIT WORKFLOW CATEGORIES

| | |
|---|---|
| A FORM FOR ADDING A | Category name |
| WORKFLOW | |
| CATEGORY | Background color |
| | Text color |
| LIST OF EXISTING | For each category |
| CATEGORIES | Edit the category |
| | Hide the category from edit mode |
| | Reorder the category |

Additionally, the software remembers the order of categories and presents them to the user as such to assist in proposal creation. The order of categories is changed/reordered with the use of arrows (i.e. move up, move down arrows) that are displayed in the top right corner of the category box. A fixed footer contains a variety of useful features, including a link to a calculator for calculating materials, a link to add a new category, an area for displaying running totals, a project and a section total/markup, and links to each category in use within the estimate. By clicking on one of the category links, the user is taken to an anchor point within the page (preferably via automatic scrolling) to the appropriate location within the selected category.

As the user complies the proposal, a running total is visible in the bottom right hand corner of the screen. In the preferred embodiment, two totals are displayed, with the first total being associated with the area (heading) the user is currently viewing, and second total showing the total for the entire project. As can be appreciated, the area and total will be same if only one heading is included in the proposal.

A form to enter allowance items for each specific area/heading is included in the bottom of the edit mode page. Allowance items can be saved as a template. There is a button in the top right corner to save as template or select a template to import. Allowance items provide a customer with an allowance for items used in the project, and aid in preparing a complete estimate. In a non-limiting example, the system can include three price levels for allowance items in order to provide a prospective client with a visual of price differences (i.e. Level 1 Toilet $190; Level 2 Toilet $250; Level 3 Toilet $340). Each area/heading can include its own set of allowance items, which appear directly after the description of work to be performed for each area/heading on the final printed proposal.

When the user has finished adding information to edit mode, the system provides the user with the option to preview the finished estimate, save the estimate as a template, or print the estimate. The top right-hand corner of edit mode includes a button labeled “make this a template”. Selecting this button saves the current page, including all line items and allowance line items as a template for later use. This feature is particularly useful for estimating common projects. A view estimate mode provides a form for entering the payment structure for the proposed work/service. In the preferred embodiment, the payment structures can be saved as a template. This is accomplished via a button in the top right corner that enables a user to save as template or to select a template to import. A running dialogue box assists with creating the payment structure, which ensures the payments add up to the total price included in the project. When printed, the proposal prints in a hierarchical outline format that provides all the necessary details that would be found in a typical proposal/contract, including date, company info, company logo, prospective client information, estimate number, description of work to be performed, proposed payment structure, terms and conditions, signature lines, and the like.

A variety of printing/signature options are provided within the system. As a non-limiting example, estimates, addendums, and change orders can be printed, saved as a PDF, or emailed directly to a customer. If customers chose to receive electronic copies of the created documents, they are then provided with an option for electronically signing the forms in order to accept the document. In a non-limiting example if the user selects the “sign request” button, the system sends a link to the customer's email address. The link includes a temporary password to view the document. When the customer follows the link and enters the appropriate password, they can the view the full document online. Additionally, if the customer accepts the terms of the proposal, they can electronically sign the documents. When this occurs, the business owner will receive notification. Alternately, for in-home estimates, customers can electronically sign the documents on an electronic tablet. The signed document can then be emailed to the customer or directly printed from a portable printer.

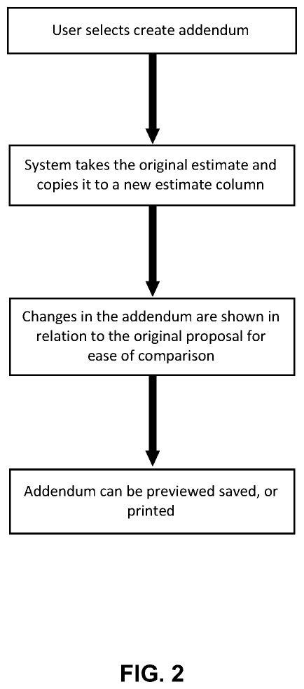

Referring now to FIG. 2, there is shown a flowchart illustrating the steps for addendum creation. If the client desires to see changes to the proposal, a contractor can create an addendum. The addendum feature of the present invention takes the original estimate and copies it to a new estimate column. The user then enters edit mode, where the necessary changes are added in as requested by the client. Here, the user edits the addendum in a manner similar to proposal creation, as described above. The changes in the addendum are shown in relation to the original proposal for ease of comparison. An example of the changes can include line items, descriptions, quantity increase/decrease, price increase/decrease, and the like. Changes to allowance items will also display the same changes.

An example of the menu functions related to line item categories that can be edited are found in Table V:

TABLE V
SAVED LINE ITEMS

| | |
|---|---|
| SEPARATE SECTIONS FOR | |
| EACH CATEGORY | |
| EACH SECTION HAS A FORM | |
| TO ADD A NEW CUSTOM ITEM | |
| EACH SECTION HAS A TABLE | For each category |
| SHOWING ALL SAVED | Delete line item |
| LINE ITEMS | Edit line item |
| | Change quantity of line item |
| | Change price of line item |

An example of the menu functions related to default item categories that can be edited are found in Table VI:

TABLE VI
DEFAULT SINGLE ITEMS

| | |
|---|---|
| SEPARATE SECTIONS FOR EACH CATEGORY | |
| EACH SECTION HAS A FORM TO ADD A NEW | |
| SINGLE DEFAULT ITEM | |
| EACH SECTION HAS A TABLE SHOWING ALL | For each category |
| DEFAULT ITEMS | Delete line item |
| | Edit line item |

Once the changes are complete, the addendum can be previewed saved, or printed, as described above. If the payment schedule needs adjustment, the software alerts the user prior to printing to allow for the necessary changes to be incorporated. Once printed, each line item that has been deleted, added, or changed is highlighted with an explanation of the change (i.e. price increased, quantity decreased, description changed, etc.). The addendum process can be repeated indefinitely until the proposal is accepted.

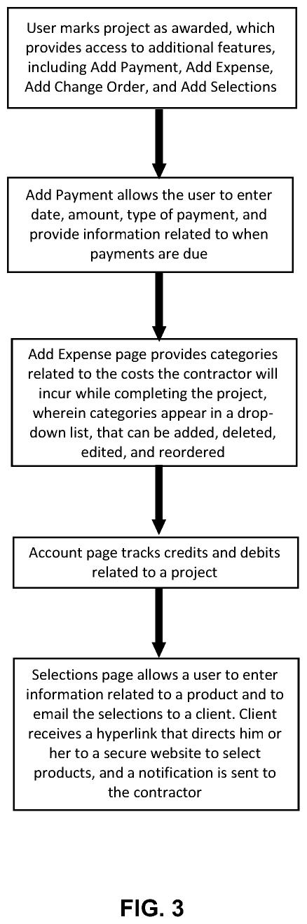

Referring now to FIG. 3, there is shown a flowchart illustrating the steps for contract awarding. Once the proposal (estimate or addendum) is accepted, the user marks the project as awarded in the software. Marking a project as awarded provides access to additional features, including Add Payment, Add Expense, Add Change Order, and Add Selections.

An example of the expense categories that can be edited are found in Table VII:

TABLE VII
EDIT EXPENSE CATEGORIES

ADD EXPENSE CATEGORY BY TYPE (Either project expense or
company expense)
REORDER EXPENSE CATEGORIES
DELETE EXPENSE CATEGORIES
ONE FORM FOR ADDING EXPENSES
ONE TABLE SHOWING COMPANY EXPENSE
CATEGORIES
ONE TABLE SHOWING PROJECT EXPENSE
CATEGORIES

The Add Payment page allows the user to easily enter the date, amount, type of payment (i.e. cash, credit, check, check number, etc.). Additionally, the software contains information related to what payments are due based on the payment schedule for each project that was included in the proposal creation section. Payments, expenses, and payment schedules can be readily viewed on the Account page for each project.

An example of the payment terms categories that can be edited are found in Table VIII:

TABLE VIII
EDIT SAVED PAYMENT TERMS

```
FORM TO ADD NEW PAYMENT TERM
    Term
    Description
    Price
LIST OF EXISTING PAYMENT TERMS
DELETE, EDIT DESCRIPTION, EDIT PRICE
FOR EACH TERM
```

The Add Expense page provides categories related to the costs the contractor will incur while completing the project (i.e. materials, payroll, rentals, etc.). These categories are customizable in the Settings page. Expense categories appear in a drop-down list, and can be added, deleted, edited, and reordered in a manner that provides the most efficiency based on an individual contractors' needs.

The Account page functions in a manner similar to conventional accounting software that is well understood in the art, and is designed to track credits and debits related to a project.

The Selections page is directly related to allowance items. As can be appreciated, clients often require assistance with selecting fixtures (i.e. appliances, toilets, and the like) for their projects. The Selections page allows a user to enter information related to a product (i.e. description, price, URL, photo, etc.) and to email the selections to a client. A client will receive a hyperlink that directs him or her to a secure website. The website displays the information related to the products uploaded by the user to the Selections page. Once the client has reviewed the selections, he or she can click a button to select the desired fixture(s). Once selection has occurred, the system sends a notification to the user indication that a selection has been made.

In addition to the above, the software of the present invention handles change orders. As can be appreciated, change orders are substantially similar to addendums, with the main difference being that change orders occur once the job has been awarded. The process for performing a change order is the same as for editing and printing addendums, as described above. Change orders differ in this regard in that the terms and conditions are different from the estimates and addendums.

Another feature of the present invention is its ability to print simple invoices. As can be appreciated, some projects do not require a proposal, but instead only need an invoice that details completed work. A non-limiting example of such a circumstance would be when a contractor is hired to install a door knob. In a situation such as this, the user can create a Simple Invoice. Simple Invoices are edited in the same manner as an estimate, as described above. The difference here is that the Simple Invoice is printed in an invoice format without payment schedules or allowance items.

Invoices can also be created from payment schedules on larger projects. This is particularly beneficial for billing a client for a completed portion of a job. The user can access the Account page for a project and can select “create invoice” from the menu adjacent to the scheduled payment for project section. Once a payment is recorded, the software shows the payment in the schedule as paid. The payment schedule will also reflect partial payments and over payments. Over payments will auto deduct the difference from future payments.

A final aspect of the present invention is the Settings page. The Settings page allows a user to change the settings on multiple aspects of the software. Non-limiting examples of the settings that can be changed are described in the Tables below:

Overall, the present invention provides contractors with an all-in-one solution for the estimating and contract creation process. The software handles all aspects, from organizing client contact information all the way through collecting payments and calculating taxes. The ability of the software to be customized enables each contractor to reorder the screens and information in the most efficient manner based on their individual needs. The software also provides a convenient system for interfacing with clients by providing them with a website for making selections, and for clearly illustrating the differences between the original contract and addendums. The system/software reduces the time and resources required for the estimating process, minimizes estimating errors, and provides clarity to clients, which will increase the percentage of contracts awarded to the user while minimizing the costs associated with their creation.

It is therefore submitted that the instant invention has been shown and described in what is considered to be the most practical and preferred embodiments. It is recognized, however, that departures may be made within the scope of the invention and that obvious modifications will occur to a person skilled in the art.

Therefore, the foregoing is considered as illustrative only of the principles of the invention. Further, since numerous modifications and changes will readily occur to those skilled in the art, it is not desired to limit the invention to the exact method and operation shown and described, and accordingly, all suitable modifications and equivalents may be resorted to, falling within the scope of the invention.

I claim:

1) A computer-implemented, cloud-based storage/software system for creating contracts, estimates, proposals, addendums, and change orders related to a work project, the system comprising:
at least one data processing system;
a customer database, wherein said customer database comprises data related to customer contact information, project type, tiered allowance levels, and a client status menu, wherein said client status menu comprises new lead, current customer, and archived customer;
a project database, wherein said project database comprises data related to one or more active project headings and one or more active project subheadings associated with said work project to be completed;
an edit mode comprising a plurality of categories, a plurality of customizable actions associated with said plurality of categories, a quantity tool, and a measurement tool;
a pre-populated line item database, wherein said pre-populated line item database comprises a plurality of customizable categories containing commonly used commands and a create new line item menu for creating commonly used commands not already stored within said pre-populated line item database;
a running total window comprising a first cost associated with said active project heading and a second cost associated with a total for the said work project;
an allowance item database, wherein said allowance item database comprises data associated with the cost of items used in said work project, data associated with tiers for the cost of different levels of items for use in said work project, a means for selecting different tiers of items, and a window displaying the cost difference between said tiers;
a proposal creation mode, comprising a preview option, a save proposal as template option, and a print proposal option;
an addendum creation mode, comprising a proposal editor that provides a first window displaying said proposal and a second window displaying the changes in said proposal, wherein said proposal and said changes are shown in relation to one another for comparison;
a change order creation mode, comprising a change order editor that provides a first window displaying said proposal and a second window displaying the changes in said original proposal, wherein said original proposal and said changes are shown in relation to one another for comparison;
a payment database; and,
a simple invoice function.

2) The system of claim 1, wherein said system continually saves work as it is completed.

3) The system of claim 1, wherein said system further comprises a line item markup tool that adjusts the markup rate, determines whether said line item is taxable, adjusts the tax rate, and provides a means to add said line item to said proposal.

4) The system of claim 1, wherein said system further comprises a fixed footer comprising a link to a calculator, a link to add a new category, an area for displaying running totals, a project and a section total, and links to each category in use within said estimate.

5) The system of claim 1, wherein said system further comprises a tool for the reordering of categories, wherein said categories can be reordered with the use of arrows.

6) The system of claim 1, wherein said system further comprises an expense database, wherein said expense database comprises materials, payroll, and rentals.

7) The system of claim 1, wherein said system further comprises a selections database, wherein said selections database comprises information related to a product, including a description, a price, a URL, and a photo, wherein a client can access, review, and select one or more of said products for inclusion in said proposal.

8) A computer-readable, non-transitory medium encoded with computer instructions, which when executed, enables a computer system to generate contracts, estimates, proposals, addendums, and change orders related to a work project, the computer instructions comprising:
at least one data processing system;
a customer database, wherein said customer database comprises data related to customer contact information, project type, tiered allowance levels, and a client status menu, wherein said client status comprises new lead, current customer, and archived customer;
a project database, wherein said project database comprises data related to one or more active project headings and one or more active project subheadings associated with said work project to be completed;
an edit mode comprising a plurality of categories, a plurality of customizable actions associated with said plurality of categories, a quantity tool, and a measurement tool;
a pre-populated line item database, wherein said pre-populated line item database comprises a plurality of customizable categories containing commonly used commands and a create new line item menu for creating commonly used commands not already stored within said pre-populated line item database;
a running total window comprising a first cost associated with said active heading and a second cost associated with a total for the said work project;
an allowance item database, wherein said allowance item database comprises data associated with the cost of items used in said work project, data associated with tiers for the cost of different levels of items for use in said work project, a means for selecting different tiers of items, and a window displaying the cost difference between said tiers;
a line item markup tool that adjusts the markup rate, determines whether said line item is taxable, adjusts the tax rate, and provides a means to add said line item to said proposal;
an expense database, wherein said expense database comprises materials, payroll, and rentals;
a selections database, wherein said selections database comprises information related to a product, including a description, a price, a URL, and a photo, wherein a client can access, review, and select one or more of said products for inclusion in said proposal;
a proposal creation mode, comprising a preview option, a save proposal as template option, and a print proposal option;
a fixed footer comprising a link to a calculator, a link to add a new category, an area for displaying running totals, a project and a section total, and links to each category in use within said estimate;
an addendum creation mode, comprising a proposal editor that provides a first window displaying said proposal and a second window displaying the changes in said proposal, wherein said proposal and said changes are shown in relation to one another for comparison;
a change order creation mode, comprising a change order editor that provides a first window displaying said proposal and a second window displaying the changes in said original proposal, wherein said original proposal and said changes are shown in relation to one another for comparison;
a payment database; and,
a simple invoice function.

9) The computer-readable non-transitory medium of claim 8, wherein said system continually saves work as it is completed.

10) The computer-readable non-transitory medium of claim 8, wherein said system further comprises a line item markup tool that adjusts the markup rate, determines whether said line item is taxable, adjusts the tax rate, and provides a means to add said line item to said proposal.

11) The computer-readable non-transitory medium of claim 8, wherein said system further comprises a fixed footer comprising a link to a calculator, a link to add a new category, an area for displaying running totals, a project and a section total, and links to each category in use within said estimate.

12) The computer-readable non-transitory medium of claim 8, wherein said system further comprises a tool for the reordering of categories, wherein said categories can be reordered with the use of arrows.

13) The computer-readable non-transitory medium of claim 8, wherein said system further comprises an expense database, wherein said expense database comprises materials, payroll, and rentals.

14) The computer-readable, non-transitory medium of claim 8, wherein said system further comprises a selections database, wherein said selections database comprises information related to a product, including a description, a price, a URL, and a photo, wherein a client can access, review, and select one or more of said products for inclusion in said proposal.

15) A computer-implemented, cloud-based storage/software system for creating contracts, estimates, proposals, addendums, and change orders related to a work project, the system comprising:
at least one data processing system;
a customer database, wherein said customer database comprises data related to customer contact information, project type, tiered allowance levels, and a client status menu, wherein said client status comprises new lead, current customer, and archived customer;
a project database, wherein said project database comprises data related to one or more active project headings and one or more active project subheadings associated with said work project to be completed;
an edit mode comprising a plurality of categories, a plurality of customizable actions associated with said plurality of categories, a quantity tool, and a measurement tool;
a pre-populated line item database, wherein said pre-populated line item database comprises a plurality of customizable categories containing commonly used commands and a create new line item menu for creating commonly used commands not already stored within said pre-populated line item database;
a running total window comprising a first cost associated with said active project heading and a second cost associated with a total for the said work project;
an allowance item database, wherein said allowance item database comprises data associated with the cost of items used in said work project, data associated with tiers for the cost of different levels of items for use in said work project, a means for selecting different tiers of items, and a window displaying the cost difference between said tiers;
a proposal creation mode, comprising a preview option, a save proposal as template option, and a print proposal option;
an addendum creation mode, comprising a proposal editor that provides a first window displaying said proposal and a second window displaying the changes in said proposal, wherein said proposal and said changes are shown in relation to one another for comparison;
a change order creation mode, comprising a change order editor that provides a first window displaying said proposal and a second window displaying the changes in said original proposal, wherein said original proposal and said changes are shown in relation to one another for comparison;
a payment database; and,
a simple invoice function.
